(19) United States
(12) Patent Application Publication
(10) Pub. No.: US 2009/0030795 A1
(43) Pub. Date: Jan. 29, 2009

(54) PAYMENT SYSTEM AND METHOD FOR INSURANCE PREMIUM PAYMENTS

(76) Inventors: Henry Winchester, Newtown Square, PA (US); Brian Thompson, Glen Arm, MD (US)

Correspondence Address: PERKINS COIE LLP, POST OFFICE BOX 1208, SEATTLE, WA, 98111-1208, US

(21) Appl. No.: 12/178,581

(22) Filed: Jul. 23, 2008

Related U.S. Application Data
(60) Provisional application No. 60/951,376, filed on Jul. 23, 2007.

(51) Int. Cl. G06Q 30/00; G06Q 40/00

(52) U.S. Cl. 705/14; 705/40

(57) ABSTRACT

In certain embodiments, a system and method for insurance premium payment is provided that automatically charges recurring insurance premiums to a credit or debit card chosen by the consumer. The system may apply a reward component and a special interest rate component to the charged premium so that card holders and their insurance companies share in the financial benefits of card usage.

### CROSS-REFERENCE TO RELATED APPLICATIONS

This application claims the benefit of U.S. Provisional Patent Application No. 60/951,376, filed Jul. 23, 2007, which is incorporated herein by reference in its entirety, inluding drawings.

### BACKGROUND

Consumers commonly pay for many of their products and services using credit cards, charge cards, debit cards, bankcards and like instruments rather than using cash or checks. Consumers do this because they find it more convenient than sending or using cash or checks. Credit cards present unique advantages insofar as they provide a revolving line of credit that can be accessed when personal funds are low. Consumers are inclined to use credit cards versus other means for purchases because itemized reports of transactions (citing amounts and merchant names) are generated each month. This is useful for monitoring one's spending habits, detecting fraud or errors, disputing charges, proving purchase when returning items without a conventional receipt, and providing expense records for end-of-year tax purposes.

In fact, it is increasingly common in today's so-called “plastic economy” that consumers use the credit card as a first, rather than last, resort. Many consumers use credit cards for most non-trivial transactions, taking advantage of the 20-25 day interest-free grace period and paying their balances off each month, sometimes thousands of dollars. At the other end of the spectrum, many consumers who have expenses that exceed their monthly income on a regular basis use the available revolving credit to manage their spending flow. In sum, there is a large body of credit cardholders in modern society who engage in a significant volume of transactions on a regular, continuous basis.

The modern plastic economy greatly benefits merchants and service providers because the convenience and instant credit access lead to greatly increased sales. They also benefit the card issuer (issuing bank) because for each transaction an “interchange” fee (typically 1-4%) administered by the card associations (e.g., Visa® or MasterCard®) is distributed to the issuer (deducted from the overall transaction amount). Moreover, the card issuer benefits from the elevated interest payments made by consumers carrying a balance. Therefore, in the card issuer/merchant/customer model of the credit card system, the card issuers and merchants receive substantial benefits.

Generally, consumers tend to use their conventional credit cards for certain types of purchases, such as retail transactions in shopping malls, groceries at foodstores, dinner at restaurants, airline tickets and so forth. The credit card's attributes make it well-suited for use in such transactions and the average consumer is likely to reach for his/her credit card rather than for cash in such circumstances due to convenience.

In contrast, consumers do not tend to use credit cards as frequently for “service industry” payments—often recurring charges—such as those for insurance companies, cable television providers and utilities. This is because the “convenience factor” associated with paying a recurring charge (such as an insurance premium) by credit card is somewhat attenuated compared to other transactions where credit cards exhibit a clear advantage over checks or cash. Merchants such as these have been reluctant to offer the card payment option due to concerns about paying interchange fees—not recognizing the benefits in higher tickets and improved collection rates. In general, then, while more and more consumers are using credits cards for their purchases, this tends not to be the case with insurance premiums. As a practical matter, insurance companies, which in all other respects are well-capitalized and critical players in the national economy, are a conspicuously absent beneficiary from the issuer/merchant/customer credit card relationship. Moreover, there is no other mechanism for loyalty- or affinity-building for insurance companies that is based on the consumer's credit or debit card. These are significant disadvantages.

Some card issuers have sought to employ rewards in order to increase use of credit cards. Credit card rebate systems allow consumers to earn points for every dollar spent on purchases made with the card. Many cards also offer “Double Point” incentives to make purchases at restaurants, gas stations and other specified merchants. Points earned may be redeemed by the consumer for goods or services of their choice, such as travel, electronics, books, clothing, gas, or other sundries. Additionally, some card issuers have used low introductory interest rates for opening accounts or transferring balances in order to attract consumers to use their card. However, such low rate credit cards and reward systems provide no particular benefits to insurance companies. Consumers currently receive little or no benefit from their credit or debit cards for enrolling in a recurring premium payment program with an insurance company, therefore they lack the incentive to do so.

### SUMMARY

Accordingly, in certain embodiments, incentives and benefits for consumers to pay their insurance premiums by credit or debit card, which in turn benefits the insurance company with improved collection, renewal rates and other benefits, including for example, potential customer loyalty, is provided.

In certain embodiments, a system and method for insurance premium payment is provided that automatically charges recurring insurance premiums to a credit or debit card chosen by the consumer. The system may apply a reward component and a special interest rate component to the charged premium so that card holders and their insurance companies share in the financial benefits of card usage.

In certain embodiments, a reward component is provided where, e.g., the consumer earns “Double Points” for each premium payment charged by the insurance company. Points earned may be accumulated over time and may be applied toward existing rewards systems that the consumer may be enrolled in or signs up for. Points may be redeemed for travel, gift certificates, electronics, or other redeemable products or services.

In addition to the reward component, a special low or zero interest rate may be assigned to a recurring premium payment for a predetermined time. For example, the special interest rate may start at 0% for a short period of time, and then may adjust to a low rate greater than 0%. The interest rate may vary depending on how often the premiums are charged, depending on the cost of the premiums charged, or depending on other factors which are set to trigger the assignment of interest rates or interest rate adjustments.

In certain embodiments, the system and method described herein may by implemented by a computer, computerized system, server based system or other automated system.

These and other aspects of the present invention are elucidated further in the detailed description.

### BRIEF DESCRIPTION OF THE DRAWINGS

The accompanying drawings are included to provide a further understanding of various embodiments of the invention and are incorporated in and constitute part of this specification, illustrate several embodiments of the invention and, together with the description, serve to explain the principles of embodiments of the invention. It will become apparent from the drawings and detailed description that other objects, advantages and benefits of the invention also exist.

FIG. 1 is a block diagram illustrating the relationship between cardholders, insurance provider, and card issuers or associations with arrangements with the insurance concern according to an embodiment of the present invention.

FIG. 2 is a block diagram according to an embodiment of the invention illustrating the components of the insurance company billing interface.

FIG. 3 is a flowchart illustrating a method according to an embodiment of the invention for providing benefits to cardholders for linking recurring insurance premium payments to a selected debit or credit card.

FIG. 4 is a block diagram of one embodiment of the Way2Pay™ system or method illustrating the interaction and relationships between card associations, card processors, card issuers (PF/Bank), and insurance companies.

### DETAILED DESCRIPTION

Additional features and advantages of the embodiments discussed herein will be set forth in the description that follows and in part will be apparent from the description, or may be learned by practice of such embodiments. The objectives and other advantages will be realized and attained by the system and methods, particularly pointed out in the written description and claims hereof as well as the appended drawings.

The following description is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

The system and method described herein (which may be referred to as Way2Pay™) is advantageous in a number of respects. It is beneficial to card issuers because it encourages card use, the creation of new accounts, and maintenance of existing accounts. It is beneficial to a card issuers and/or banks as it allows them to offer all of their products and financial services with an easy payment program. The system provides insurance companies with a more reliable and predictable payment method. It is beneficial to associated insurance concerns who are exposed to new markets of potential customers and expanded opportunities to create a loyalty and retention platform for existing customers. Because higher premiums would result in higher point rewards combined with zero or low interest rates associated with such premiums, cardholders may decide to increase levels of insurance coverage or purchase new products outright in order to incur greater rewards at little excess cost to them. The system opens the door for unique partnering relationships, not otherwise readily established, between banks, credit card associations and insurance concerns. Finally, the system is advantageous to cardholders who receive the benefit of redeeming points earned on goods and services that are desirable to them and charging premium payments to a credit or debit card while being subjected to a low or 0% interest rate.

The present system or method described herein is also beneficial to insurance companies by providing the following: new selling advantages; upsell and cross-sell opportunities; billing credit card efficiencies; improved premium collection rates; higher per transaction sales; monthly communication opportunities via billing statements; unique customer benefits; more immediate investment of premiums; substantial reduction in administrative and premium payment processing costs; generates a revenue source; and/or investment yield on larger daily balances. The present system or method described herein is beneficial to banks or card issuers because, e.g., the system or method generates large sum transactions and substantial new loan volume, saves marketing and development costs, and generates substantial new fees and interest income.

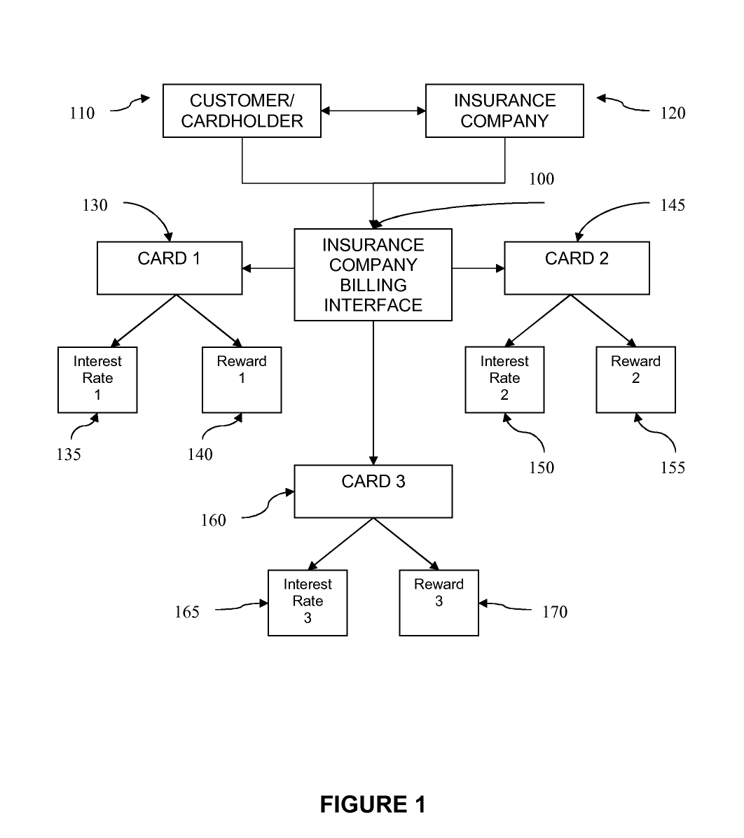

FIG. 1 provides an overview of the relationships between the various components according to one embodiment of the present invention. The components may comprise a cardholder 110 who is a customer or potential customer of insurance company 120 (e.g., provider of property and casualty insurance and/or life and health insurance), an insurance company billing interface 100, and a plurality of credit and debit cards (Card A, B, C) from issuers and associations 130, 145, 160, all of which have arrangements with the insurance company for pre-determined interest rates 135, 150, 165 and rewards 140, 155, 170 associated with recurring insurance premium payments. In this embodiment, there are three card issuers that have arrangements with the insurance concern or company, however this should not be seen as limiting as there may be more or less than three card issuers.

The insurance company billing interface 100 may include an interactive database or a server-based system, which is used by an insurance company participating in the Way2Pay™ program associated with the present invention, or be otherwise configured to place or charge premiums on customer debit or credit cards on a recurring basis, which results in automatically subjecting the premium to pre-determined interest rates and rewards. For example, a 0% or low interest rate may be applied to a premium payment and the premium payment may be applied to a rewards component, e.g., awarding double reward points for such payment. The premium payment is charged to a credit or debit card and the payment may be paid by the card holder to the card issuer in various intervals over a predetermined interval of time, with the payment having a 0% or low interest rate. This allows a card holder the benefit of deferring payment for little or no extra cost and reducing the overall rate of the credit or debit card. In certain embodiments, a 0% interest rate may be applied to all premium balances for at least 90 days, and preferably 120 days or more. The interest rate and duration may be driven by the cost of money both internally and externally (e.g., LIBOR rates), the condition of the credit market, and the perceived advantage of gaining a major inroad to the marketplace.

The insurance company billing interface 100 may also carry out or be provided with technology to carry out various operations such as maintaining account data, processing transactions and interacting with the insurance company, card holders and card issuers and associations. An enrolled cardholder/customer 110 may be given limited access to the interface 100 via an issued ID/password in order to change personal preferences with respect to his or her recurring payments and benefits associated with them.

The recurring payment may be scheduled to occur annually, semi-annually, quarterly, or monthly. In one embodiment, the customer incentives may be greater when there are fewer payments made per year, for example, payments made annually, bi-annually, or quarterly. A customer may receive greater rewards and a lower interest rate for a longer period of time if they pay annual insurance premiums in full. In another embodiment, the insurance company may choose to further incentivize the customer to pay by credit or debit card by allowing the customer to renew their insurance policy at their current rate (without an increase in rates) if they agree to continue using the recurring premium payment program for a fixed period of years. Other incentives and rewards are contemplated which may encourage customers to may payments by credit or debit cards.

In certain embodiments the system and method described herein may by implemented by a computer or computerized system.

### An Insurance Company Billing System

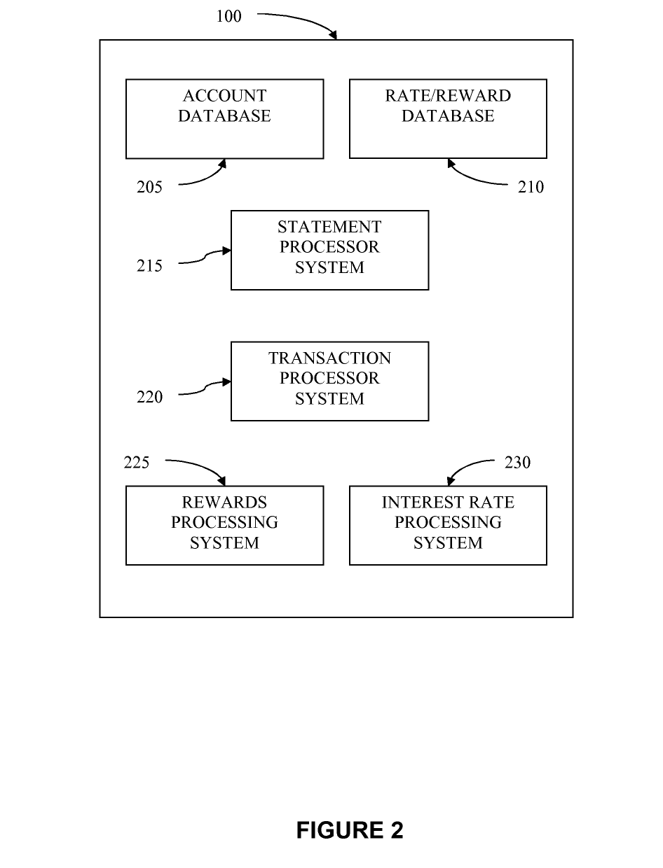

FIG. 2 illustrates an embodiment of an insurance company billing interface, which may include an account database 205, rate/reward database 210, statement processor system 215, transaction processor system 220, rewards processing system 225, and interest rate processing system 230. Those of skill in the art should appreciate that the allocation of the aforementioned elements is exemplary and functional, the purpose here being to explain the present invention most clearly. The functions performed by said elements could be allocated differently, such that the elements could be combined or further divided depending on the requirements of specific implementation into hardware and/or software. Additionally, the elements of the system need not be co-located, but could reside at geographically distinct locations and could interface using communications technologies well known in the art, such as direct-dial connections, hard-wire link, the Internet or IPng (Internet Protocol next generation), satellite, microwave, cellular networks and so on.

In certain embodiments, account database 205 may include one or more data modules having account data for insurance company customers who choose to enroll in the Way2Pay™ program. Data may include, e.g., insurance account data, recurring payment information (monthly, quarterly, etc) and credit or debit card data for each customer. Rate/reward database 210 may include a database which may be accessed by credit or debit card issuers or associations and is capable of generating information tables for customers regarding rewards programs and interest rates available for premiums paid on particular cards. Statement processor system 215 may prepare statements of account activity to be sent to customers when premiums are charged. Such statements may include a summary of charges, balance due, accrued rewards, interest rate applied and other account related information.

Transaction processor system 220 is a computerized system used by an insurance company, which may be a server-based system, for processing recurring customer payment transactions in the credit card-based system. Rewards processing system 225 works in cooperation with transaction processor system 220 to perform the processing of reward points based on amounts charged. The amount of reward may differ based on the amount of the premium, frequency of premium payment, or other incentive systems. Additionally, interest rate processing system 230 works in cooperation with transaction processor system 220 to place insurance premium payments into interest rate buckets or categories based on, e.g., the SIC, Merchant Code or MCC of the insurance company. Interest rates or special interest rates may be conferred on various premium payments. The interest rate bucket may differ based on the amount of premium payment, the frequency of premium payment or other tiered systems. The above processors and systems can optionally perform their tasks automatically.

### Way2Pay™ Method for Providing Rewards and Special Interest Rates for Charging Insurance Premiums

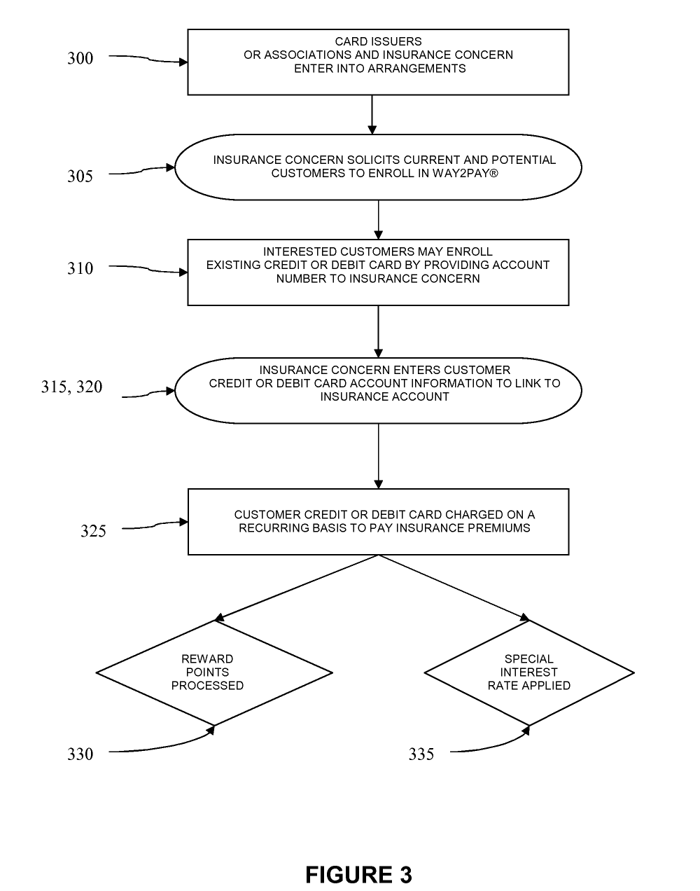

FIG. 3 depicts one embodiment of a method for integrating recurring premium payments with rewards and special interest rates in an insurance premium payment system.

Indeed, one or more card issuers or associations may enter into an arrangement with one or more insurance concerns 300, establishing a special interest rate and rewards for any customer or potential customer of the insurance concern who agrees to charge their insurance premiums on a particular issuer or association's card. Insurance concern 300 solicits current and potential customers to enroll in Way2Pay™ 305. Interested customers may enroll a pre-existing credit or debit card account 310. In another embodiment, the customer may choose to apply for a new card at the time of enrolling in the Way2Pay™ program.

The customer can provide the insurance concern with a credit or debit card account number 315 from an existing or new card. Optionally, the information is automatically obtained through the customer applying for a new card. The insurance concern 300 enters this information into the insurance company billing interface to link the insurance accounts and credit or debit accounts 320. The customer's credit or debit card is then charged on a recurring basis (e.g., monthly, quarterly, semi-annually, or annually) agreed to upon enrolling in program 325. A pre-determined reward is processed as a result of the charge and may be applied to a rewards system associated with the card 330. In another embodiment, the rewards are “points” which accumulate with each insurance premium dollar charged to the card. The card issuer or association can identify insurance premium payments from an insurance concern or company that the card issuer or association maintains an arrangement with (as in 300) and/or separate such payments, e.g., by the SIC, or Merchant Code or MCC of a company or concern, and can subsequently apply a pre-determined special low interest rate to such premium payments 335 or apply the insurance premium payment toward a rewards component. In certain embodiments, a credit card processing system has classification codes that permit a bank or card issuer or processor to segregate insurance premium transactions from all other credit card activity. Such transactions can then be noted as eligible for the interest free or low interest period and/or rewards programs.

In certain embodiments payment made on a Way2Pay™ credit or debit card, such as an insurance premium, a co-pay, a deductible, and any transaction where a source or classification code identifies it as an insurance related transaction, will be eligible for an interest free or low interest program or rewards program. Certain payments may be recurring and other payments may be one time payments. Such payments may be automatically charged.

In certain embodiments, the content of the rewards program may be determined by the credit or debit card issuer or bank in concert with Way2Pay™'s marketing campaign. An insurance company may also add to the rewards program. Examples of rewards include, free airline miles, discounts on products and services, insurance company dollars to apply toward premiums, additional insurance coverage, e.g., a life policy dividend product, and/or cash back rewards.

Once the customer has been enrolled in the Way2Pay™ program, he or she may be given limited access to the server-based system in order to redeem reward points, change payment terms, add insurance coverage, products or services, change address or other account information and other personal preference issues. The access would be limited to the areas personal to a particular customer and may be accessed via a password or other suitable mechanism known in the art for indicating authorization or providing identification.

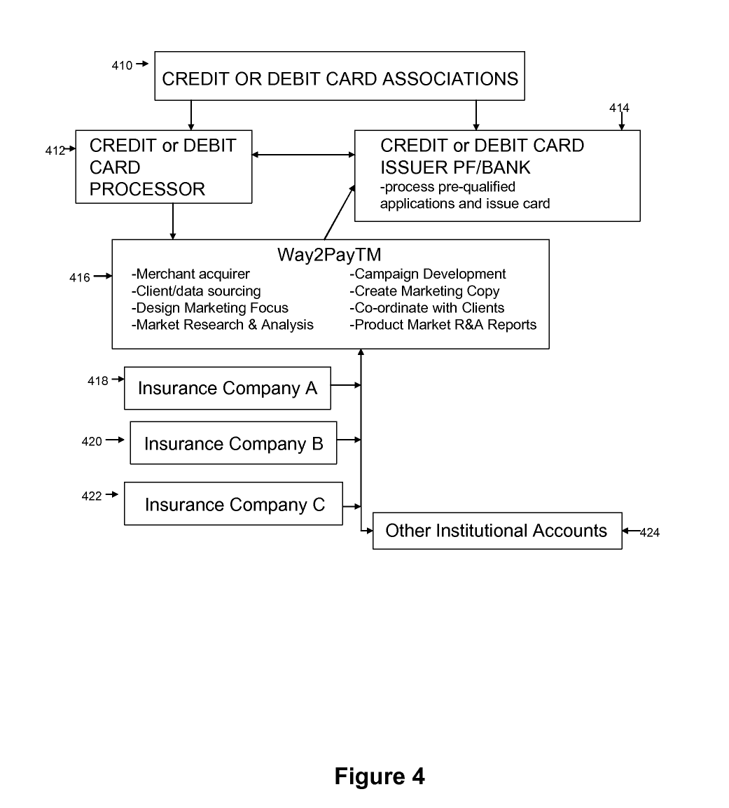

FIG. 4 depicts one embodiment of the Way2Pay™ system or method showing the interaction and relationships between card associations, card processors, card issuers (PF/Bank), and insurance companies, as facilitated by Way2Pay™. A card issuer or bank 414 issues a credit or debit card (e.g., a Way2Pay™ card that may be used by customers to pay their insurance premiums), the processing of which may be handled by a card association or processor 410, 412. Way2Pay™ 416 provides the following services or acts in the following capacities: merchant acquirer, client/data sourcing, design marketing focus, market research & analysis, campaign development, creates marketing copy, co-ordinates with clients/insurance companies, product market R&A reports. Way2Pay™ brings in the merchant/client, the insurance companies, or other institutional accounts 418, 420, 422, and 424 and markets the issued cards (e.g., the Way2Pay™ cards) to such insurance companies or other institutional accounts 418, 420, 422, and 424 or to a bank's existing insurance company partners, as a mechanism for insurance companies to charge and collect insurance premium payments. The insurance company may then agree to sell or distribute these cards to their customers, or they may accept customers existing cards (cards which a customer may receive directly from a bank or from Way2Pay™), allowing customers to make premium payments using the cards and receive rewards and special interest rates. Cards may include the insurance company's name.

In certain embodiments, the Way2Pay™ Insurance Premium Payment Credit Card (IPPP) can be quickly and seamlessly deployed to current credit card paying bank customers and customers paying by other means. Way2Pay™ may serve as the merchant acquirer to various insurance companies. Way2Pay™ may be implemented into a banks existing credit client base. Way2Pay™ may help develop the marketing program for a bank's current client insurance companies and partnership banks. It will also develop marketing tools for expanding the client base and options in acquiring new insurance customers.

In certain embodiments, the Way2Pay™ system operates in conjunction with a service provider, e.g., an insurance company, to provide a team marketing effort that requires less cost to and involvement by a credit or debit card issuer. In certain embodiments, the Way2Pay™ system provides an integrated system of promotional differentiation, credit or debit card portfolio management for clients, a directed marketing campaign, and/or credit or serves as a credit or debit card application forwarder. The credit or debit card issuer, e.g., a bank, may provide the financial institutional framework, the credit or debit card application processing, credit review and authorization, and/or the payment and collection mechanism. In certain embodiments, a credit or debit card issuer or bank enters into an agreement with Way2Pay™ financial services, which provides a license to offer the Way2Pay™ IPPP program to the card issuer's or bank's customers, a revenue fee schedule, the right to use the Way2Pay™ trademark, and a Way2Pay™ program of marketing support including consulting services to assist in the launch and ongoing success of the issuer or bank.

In certain embodiments, the accounts provided by Way2Pay™ in the first round of marketing will be qualified accounts, i.e., policy holders of at least three yeas standing who have demonstrated both financial capability and responsibility. Subsequent rounds would provide accounts to policy holders of various standing, e.g., holders of policies from a range of months to years.

In certain embodiments, the Way2Pay™ system or method and services associated with this system or method may provide the following. First, an electronic process for the payment of insurance premiums (e.g., an Insurance Premium Payment Process or IPPP). Second, a co-branded affinity card to insurance companies or other service or product providers. Third, Way2Pay™ may be an affinity credit card for its own account. Fourth, complete marketing services to expand business base, credit card base, or the payment process for insurance products or other financial services.

The above described methods and systems may be used for facilitating the payment of premiums or other recurring payments for services other than insurance. For example, making payments through recurring charges for various utilities, e.g., cable television, power, gas, water or any other service is also contemplated in the embodiments described herein. Indeed, facilitating the charging of payments on a debit or credit card on a recurring basis while subjecting the payments to special interest rates and applying the payments toward a rewards program in accordance with the embodiments described herein may be a useful method or system for facilitating the sale and payment of a variety of services.

As stated above, the foregoing is merely intended to illustrate various embodiments of the present invention. The specific modifications discussed above are not to be construed as limitations on the scope of the invention. It will be apparent to one skilled in the art that various equivalents, changes, and modifications may be made without departing from the scope of the invention, and it is understood that such equivalent embodiments are to be included herein. All references cited herein are incorporated by reference as if fully set forth herein.

What is claimed is:

1. A card-based insurance premium payment system for improving collection, renewal rates, or customer loyalty comprising:
an insurance company billing interface configured to process insurance premium payment transactions and maintain an accounting of payments, rewards, and interest rates for each customer enrolled in the system, wherein an insurance premium payment is automatically charged to a card on a recurring basis by the insurance company; and
one or more modules which interact within the insurance company billing interface to assign and manage rewards and special interest rates for an insurance premium payment;
wherein the system is implemented by a computer.

2. The system of claim 1 wherein the insurance company billing interface further comprises account database, rate/reward database, statement processor system, transaction processor system, rewards processing system, and an interest rate processing system.

3. The system in claim 1, wherein the recurring premium payments may be automatically charged bi-weekly, monthly, quarterly, semi-annually, annual, or any other predetermined frequency.

4. The system in claim 1, wherein the rewards comprise points awarded for each dollar of premium payment charged.

5. The system in claim 4, wherein double points are awarded for each dollar of premium payment charged.

6. The system in claim 4, wherein points earned may be accumulated over time and may be applied toward existing rewards systems.

7. The system in claim 1, wherein a special interest rate is set for a predetermined period of time after a premium payment is charged, and increases to a default interest rate if the premium payment is not paid in full during that time.

8. The system of claim 7 wherein the predetermined interest rate is 0%.

9. The system of claim 7 wherein the predetermined interest rate is greater than 0%.

10. The system of claim 7 wherein the interest rate increases in predetermined intervals in each instance after a predetermined period of time passes in which the premium payment is not paid in full.

11. The system of claim 7 wherein the interest rate may vary depending on how often the premiums are charged or on the cost of the premiums charged.

12. The system of claim 1 wherein the insurance premium is automatically charged to a credit or debit card.

13. A method for charging insurance premiums on a credit or debit card for improving collection, renewal rates, or customer loyalty comprising:
receiving credit or debit card account information from a customer or potential customer of an insurance company and linking the customer or potential customer's insurance and credit or debit card accounts;
charging an insurance premium payment on said card on a recurring basis;
conferring a special interest rate on the insurance premium payment; and
applying the insurance premium payment toward a rewards component;
wherein the method is implemented by a computer.

14. The method in claim 13, wherein the recurring premium payments may be automatically charged bi-weekly, monthly, quarterly, semi-annually, annual, or any other predetermined frequency.

15. The method in claim 13, wherein the rewards are points awarded for each dollar of premium payment charged

16. The method in claim 15, wherein double points are awarded for each dollar of premium payment charged.

17. The method in claim 15, wherein points earned may be accumulated over time and may be applied toward existing rewards systems.

18. The method in claim 13, wherein the special interest rate is 0% for a set time after premium payment is charged, and increases to a default interest rate if not paid in full during that time.

19. The method in claim 13 wherein the predetermined interest rate is greater than 0%.

20. The method in claim 13 wherein the interest rate increases in each instance after a predetermined period of time passes in which the premium payment is not paid in full.

21. The method in claim 13 wherein the interest rate may vary depending on how often the premiums are charged or on the cost of the premiums charged.

22. A method for charging insurance premiums on a credit or debit card for improving collection, renewal rates, or customer loyalty comprising:
providing a customer or potential customer with a new credit or debit card account through a third party credit or debit card provider;
charging premium payments for insurance services on said card on a recurring basis;
conferring a special interest rate on the insurance premium payment; and
applying the insurance premium payment toward a rewards component.

23. The method in claim 22, wherein the insurance premium payment may be automatically charged bi-weekly, monthly, quarterly, semi-annually, annual, or any other predetermined frequency.

24. The method in claim 22, wherein the rewards are points awarded for each dollar of premium payment charged.

25. The method in claim 22, wherein the special interest rate is 0% for a set time after payment is charged, and increases to a default interest rate if not paid in full during that time.

26. A card-based insurance premium payment system for improving collection, renewal rates, or customer loyalty comprising:
an insurance company billing interface configured to automatically charge an insurance premium payment to a card on a recurring basis, wherein the billing interface comprises;
an account database configured to receive credit or debit card account information from a customer or potential customer of an insurance company and link the customer or potential customer's insurance and credit or debit card accounts;
a transaction processor system for processing recurring customer payment transactions;
a rewards processing system which works in cooperation with the transaction processor system to perform processing of reward points based on amounts of payment charged; and
an interest rate processing system which works in cooperation with the transaction processor system to place insurance premium payments into interest rate buckets based on an SIC or Merchant Code, and subjecting the premium payments to pre-determined interest rates;
wherein the system is implemented by a computer.

27. The system of claim 26 further comprising:
a rate/reward database accessible by credit or debit card issuers or associations and capable of generating information tables for customers regarding rewards programs and interest rates available for premiums paid on particular cards; and
a statement processor system for preparing statements of account activity to be sent to customers when premiums are charged.
